(19) United States
(12) Patent Application Publication
(10) Pub. No.: US 2004/0076938 A1
(43) Pub. Date: Apr. 22, 2004

(54) Sports equipment usage aids

(76) Inventor: Mark W. Publicover, Saratoga, CA (US)

Correspondence Address: KLARQUIST SPARKMAN CAMPBELL, LEIGH & WHINSTON, LLP, One World Trade Center, Suite 1600, 121 S.W. Salmon Street, Portland, OR, 97204-2988, US

(21) Appl. No.: 10/319,390

(22) Filed: Dec. 13, 2002

Related U.S. Application Data
(63) Continuation of application No. 09/477,127, filed on Jan. 3, 2000, now abandoned.
Application No. 09/477,127 is a continuation-in-part of application No. 09/273,308, filed on Mar. 18, 1999, now abandoned.
Application No. 09/273,308 is a continuation-in-part of application No. 09/036,203, filed on Mar. 5, 1998, now abandoned.
(60) Provisional application No. 60/078,717, filed on Mar. 20, 1998.

(51) Int. Cl. G09B 9/00

(52) U.S. Cl. 434/248

(57) ABSTRACT

An item of sports equipment having functional markings and informational markings provided thereon, the functional markings serving to place a user's hand on the item, and the informational markings conveying information about use of the item.

### RELATED APPLICATION DATA

This application is a continuation-in-part of U.S. patent application Ser. No. 09/273,308, filed Mar. 20, 1998, which is a continuation-in-part of U.S. patent application Ser. No. 09/036,203, filed Mar. 5, 1998. This application also claims priority from U.S. Provisional Application No. 60/078,717, filed Mar. 20, 1998.

### FIELD OF THE INVENTION

The present invention relates to sports equipment, such as basketballs, golf clubs, and the like.

### BACKGROUND AND SUMMARY OF THE INVENTION

Various aids are known to help players place their hands correctly on sports equipment. A familiar example is a line (or arrow) that is commonly embossed/printed along the top of molded rubber golf club grips, facilitating placement of the player's thumbs in the correct orientation. Another example is the “Hands-On” basketball, which includes painted right- and left-handprints to serve as aids for hand placement.

Such known hand-placement aids suffer from various drawbacks. It is an object of the present invention to overcome the drawbacks associated with such prior art, and to provide new functionality not heretofore contemplated.

According to one aspect of the invention, sports equipment is provided with indicia that does more than simply aid static hand placement. Taking the example of a basketball, the indicia additionally can guide the player as to the relative pressure to be applied at different points on the ball (e.g. differing finger pressures). Alternatively (or in addition), the indicia can guide the player in changing hand placement/pressure as the item is used (e.g. the dynamics of rolling and releasing the ball during foul shooting). The foregoing indicia can employ visual (e.g. color), textural, or other variations to indicate variations in pressure, and to indicate variations (e.g. in hand position or pressure) over time.

According to another aspect of the invention, plural such guide markings are provided on the ball, each such marking corresponding to a different type of ball manipulation (e.g. foul shooting, jump-shot, lay-up, chest pass, etc.)

According to another aspect of the invention, the hand placement guide (whether static, or employing the above-noted features) is tailored to the particular player's hand proportions. That is, a player with small palms and long fingers desirably employs a guide different than a player with large palms and short fingers, etc. Plural guides can be provided on a single item of sports equipment to account for the different classes of hand shapes. Preferably, however, a ball is marked for a single hand shape, thereby permitting a richer set of guide information than would be possible if the item were crowded with markings for variously-proportioned hands.

In retail distribution, a store may stock several models of basketballs, each marked for a different hand shape. The store can employ a series of cardboard templates or the like to ascertain a customer's hand shape and select a ball accordingly. Alternatively, an electronic scanning apparatus can be employed to determine the particular model of ball appropriate for each customer. (Such scanning systems are known in other contexts, such as an aid to customer shoe sizing at NikeTown stores, and are readily adaptable to the present application.)

Generally speaking, the critical element when selecting guide markings is hand shape, not hand size. While it is possible to provide different-sized balls for each shape of hand (e.g. small palm/long fingers), I prefer to provide one or a limited number of balls showing exemplary, realistic hand markings. Supplemental marking provide guidance as to how a customer with larger- or smaller-sized hands of the same or similar shape should manipulate the ball. In a simple embodiment, these markings take the form of lines down the center of each finger marking, permitting players with differently-sized hands to position their fingers correctly by laying them along the finger axis markings. Other, more complex resizing guides can of course be used.

One advantage to the foregoing proportioned hand approach (in addition to reduced retailer inventory concerns) is that it trains junior players in the correct hand-placement they will employ when fully grown. Many players suffer by adopting—as children—hand placements that expediently serve small hands, but are disadvantageous when maintained (as naturally tends to occur) after their hands have grown to full size.

According to another aspect of the present invention, an item of sports equipment is provided with a heat- or pressure-sensitive coating, laminate or fabric covering by which the pressure or contact applied to different points on the item can be determined.

The foregoing and additional features and advantages of the present invention will be more readily apparent from the following detailed description, which proceeds with reference to the accompanying drawings.

### BRIEF DESCRIPTION OF THE DRAWINGS

FIGS. 1, 2, and 3 show basketballs according to three embodiments of the present invention.

FIG. 4 shows a partial view of a basketball according to another embodiment.

FIG. 5 shows a partial view of a basketball according to another embodiment.

FIG. 6 is a detailed view of one of the fingerprint markings of FIG. 4.

FIG. 7 is a detailed view of a second graphic on the basketballs of FIGS. 4 and 5.

FIG. 8 is a detailed view of an alternative second graphic.

### DETAILED DESCRIPTION

According to one embodiment of the invention, a standard (e.g. NBA regulation) basketball is provided with handprint (or fingertip, etc.) markings (often for both hands) to aid in executing one or more shots. Several types of marking can be employed, each to convey a different type of information.

Color is one type of marking. It can be used, e.g., to convey information about changes that occur over time (i.e. temporal markings). The sequence of colors can indicate, for example, the relative length of time that a contact point is maintained between the hand and the ball. The rainbow sequence is one such sequence (although perhaps not the most intuitive): purple, blue, green, yellow, red. The first contact point to be released is colored purple. Next is blue, and so forth. Red indicates the last point of hand-contact with the ball before it is fully out-of-hand.

A second type of marking is color saturation. In this embodiment, all markings are the same color (e.g. red), but are lighter or darker to convey the information (e.g. to indicate the different stages of release).

A related type of marking is grey-scale marking, which can used to the same effect (e.g. white being the first contact point to be released, spanning through greys until full black, which is the last point of contact to be released, or vice-versa).

A third type of marking is texture. A spectrum of different textures (smooth to rough, or fine-grain to course-grain, etc.) can be applied to a ball using various known processing techniques (e.g. inks with different sized rubber grains). Again, this range of markings can be used to instruct the player in the dynamics of ball manipulation during a given shot. Textural markings have the advantage of employing the player's tactile, rather than visual, sense, so the player need not look at the ball to make use of such instructional markings.

The foregoing three types of marking have been described in the context of conveying temporal contact-release information. However, they can convey other information as well.

Another type of information that can be conveyed is force-direction information. During manipulations of sports equipment, the application of force at the contact points, in connection with hand, wrist, arm, and body movement, causes directional changes to the equipment, as well as the impartation of spin. The initial position of contact point can be indicated, e.g., by one extreme in a color/saturation/texture spectrum, and the force-direction information can be indicated by the other extreme, or by a combination of lines, colors, saturation levels, and/or textures.

An example of this would be force-direction information applied to a football. The-forward rhotion of the football as it is being thrown towards a target can be indicated by, for example, a pattern or line rendered in red, with the line oriented in the direction of the throw. Such a pattern or line could be light red in color at the start of the force-direction (e.g. start of throw), gradually increasing in saturation to dark red at the other end of the indication pattern or line, showing the termination of the force-direction. Similarly, a blue pattern or line, for example, could be used to indicate the downward force applied by the thrower at certain contact points to affect direction of the throw and impart spin. This force is applied in approximately a perpendicular direction to the force-direction applied to create the forward thrust of the football. Thus, in this rendering, the forward force-direction markings would appear in a graduated shade or red, and the downward, spin-imparting force direction markings would appear in a graduated shade of blue, perpendicular to the red markings. Both of these markings would instruct an individual as to the optimal direction in which force is to be applied to the football, and at which contact points, when executing a throw, as well as to reveal timing of relative force application (e.g., to impart spin relative to forward momentum).

Still another type of information that can be conveyed by such markings is pressure information. The firmest pressure can be indicated, e.g., by one extreme in a color/saturation/texture spectrum, with the lightest pressure being indicated by the other extreme.

With three forms of marking (color, saturation, texture), three dimensions of information can be conveyed. Thus, an exemplary basketball may be marked (1) with differently-colored indicia to indicate contact-release information; (2) with differently-saturated indicia to indicate force-direction information; and (3) with differently-textured indicia to indicate pressure information, and/or combinations thereof. The basketball may have plural sets of such multi-form markings to correspond to different shots.

Moreover, this arrangement permits one type of information to be marked as a function of another. Consider pressure as a function of time. Pressure can be indicated by color-saturation, while the passage of time can be indicated by shifts in the color spectrum. Thus, at the beginning of the shot (e.g. purple), the thumb point of contact may have the greatest pressure (indicated by a fully-saturated purple) and the middle finger may have average pressure (indicated by a mid-saturated purple). Through the course of the shot, the thumb pressure may lessen and the pressure on the middle finger may increase. At the end of the shot (e.g. red), the thumb point of contact may have essentially no pressure (indicated by a lightly-saturated red) while the middle finger may have maximum pressure (indicated by a fully saturated red).

Passage of time can be indicated by various forms of marking. For example, a band of marking can be provided at each fingertip, with the left-most saturation indicating the pressure at the beginning of the shot, and the right-most saturation indicating the pressure at the end of the shot.

(It should be recognized that other forms of marking can be employed in the present invention as well. One example is different line densities (e.g. for outlining or fill). When conveying, e.g., pressure marking, thick outlining of a part of a hand may indicate firm pressure, while thin outlining may indicate light pressure. Another is the provision of arabic numeral markings. When conveying, e.g., contact-release information, “1” can indicate a point of initial contact release, and “5” can indicate a point of final release. The cited copending application discusses other forms of marking. Still other such forms of marking can similarly be devised.)

As noted above, the markings are desirably tailored to differently-proportioned hands. The markings can be modeled after different NBA players, who naturally exhibit a range of different hand proportions. Thus, a young player who has a certain hand conformance may learn that his hands are shaped like Shaquille O'Neal's, while another may learn that his hands are shaped like Michael Jordan's.

Since the hands of NBA players are typically quite large, the markings may be scaled down to a more mid-sized hand or may employ other methods to indicate a reduced scale. Supplemental markings can be provided to aid players with differently-sized hands in using the standard instructional markings. Such supplemental markings can include, e.g., lines down the center of straight fingers, facilitating placement of larger- or smaller-fingers along the same axis.

Many NBA players grip the ball with their fingertips only, not their palms. When reflecting the scale of hands smaller than the exemplary hand(s), gripping by fingertips alone may not be practical. For this and other reasons, the markings on the ball commonly include a hand outline, even though not all parts of the hand may touch the ball—it is still a useful guide. Parts of the hand that are actually in contact with the ball are differently marked. Such an arrangement is detailed in the copending application.

The same principles are applicable to other items of sports equipment as well, including footballs, baseballs, volleyballs, tennis balls, tennis rackets, hockey sticks, golf clubs, baseball bats, etc.

In accordance with another aspect of the invention, a ball or other item of sports equipment is provided with a pressure-sensitive covering or laminate that can record the player's contact pressure at a variety of locations over the surface of the item. One way to effect this is a thin liquid crystal laminate of the type commonly used in forehead thermometers and the like, which presents different colors corresponding to different temperatures. (An example is shown in U.S. Pat. No. 5,676,465.) Since the heat transferred to the surface of the item is a function of the pressure applied, such a laminate can provide a map of pressure across the surface. (The laminate need not extend over the entire item surface.) Alternatively, known thin-film pressure sensing technology can also be employed.

The foregoing embodiments all employed markings for strictly functional purposes. Other embodiments contemplate markings—at least in part—for ornamentation or collectability purposes. These other embodiments, described below, include features which can be used in conjunction with, or in lieu of, features of the earlier-described embodiments.

One such second embodiment comprises a standard (e.g. NBA regulation) basketball that is provided with a design in the form of a handprint. The handprint can be positioned so that the tip of the middle finger is on a ball seam (or on the air valve), with the axis of the finger (and hand) orthogonal to the seam. Or the handprint can be elsewhere on the ball.

In a preferred second embodiment, the handprint is that of a famous basketball player, such as Shaquille O'Neal. Such professional players have very large hands—much larger than the ordinary consumers of basketballs.

Accordingly, while the handprint may be regarded as a user's guide to finger placement or the like, it is generally a poor tool for that purpose. The handprint design is thus not dictated purely by such function. Instead, the intent in providing the handprint is primarily ornamental.

The handprint can be of the left- or right-hand. If the handprint is that of a famous basketball player, the player's preferred shooting hand is represented.

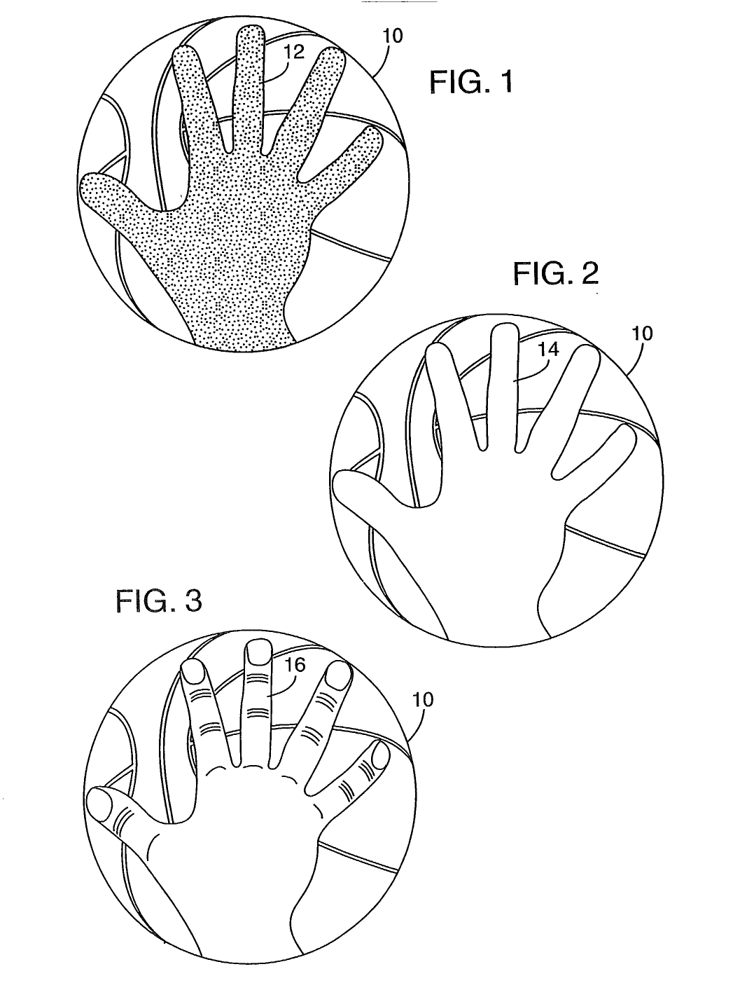

In one embodiment, a basketball 10 has a solid handprint 12 that is a solid filled-in color, accurately representing the print of a human hand (i.e. not a stylized design), with palm and five fingers. The color may be black, or any other color. Such an embodiment is shown in FIG. 1.

In another embodiment, the handprint is not filled in; instead just an outline is provided. In an exemplary such embodiment, an outline handprint 14 is formed by a single line (e.g. of ⅛^{th}, ¼, ½, or one inch thickness) that traces the perimeter of the palm and fingers, defining a single shape. Such an embodiment is shown in FIG. 2. The outline can be closed at the wrist, or left open.

In another such embodiment, plural lines can be used, defining plural closed areas (e.g. one for each of the five fingers, plus a sixth for the palm).

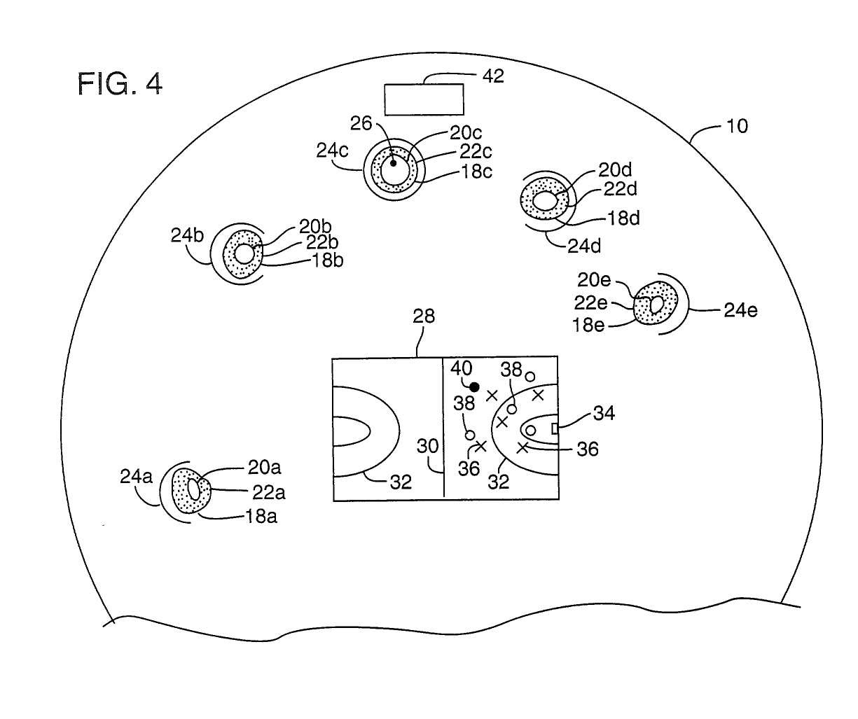

In still other embodiments, hybrid approaches may be used. For example, the hands of some professional players are so large that the ball is essentially gripped by the fingertips alone; the palm is not in contact with the ball. In this case, the fingertips (which are actually in contact with the ball) can be illustrated in a distinctive fashion (e.g., solid black, or outlined in a relatively thicker contour line, or using one of the illustration techniques described below), and the remainder of the hand can be illustrated in a shadow fashion (e.g. outlined with a thinner contour line) or otherwise distinguished. Such a ball is shown in FIGS. 4-7.

In yet another embodiment, the design is neither filled-in, nor merely an outline. Instead, arcuate line designs may be provided to emulate the patterning of fingerprints. Such patterning can be provided only in the fingertip region, or may extend to cover all of the handprint. The line width of the patterning will depend on the reproduction equipment with which the ball is printed. At one extreme, true to life patterning can be employed, with very fine line dimensions. At the other extreme, stylized prints (including stylized whorls, loops, etc) can be provided at the fingertips, or throughout the handprint.

In still another embodiment, a photographic-like reproduction of the player's hand can be provided on the ball. As shown in FIG. 3, such a photo handprint 16 can be of the palm side of the hand, or the back side, to demonstrate and teach the actual tension of the hand.

When using photographic designs, a variety of printing styles can be used.

If true color is the goal, the region on which the design will be printed may first be prepared with a white layer (e.g. paint). Then conventional four-color (e.g. cyan, magenta, yellow, black) printing techniques, such as screen printing (e.g. half tone, or line art) can be used.

In other embodiments, true color need not be used. Printing with one, two, or more “spot” colors can be employed (as contrasted with traditional CMYK color schemes). Metallic and fluorescent coloring can also be used. (The foregoing printing techniques can be used with the earlier-described designs; not just photographic designs.)

FIG. 4 shows an embodiment in which the basketball 10 has contact-release markings, pressure markings, and informational markings. As illustrated, fingertip markings 18a-18e are positioned at points corresponding to a right-handed player's contact with the basketball 10. Thus, the fingertip markings 18a-18e correspond to the position of the player's fingers as follows: 18a (thumb), 18b (index finger), 18c (middle finger), 18d (ring finger), and 18e (little finger). Adjacent each of the fingertip markings 18a-18e is a corresponding pressure marking 24a-24e. The basketball 10 has a first graphic 28 (showing a basketball court) positioned near the center of the fingertip markings 18a-18e, and a second graphic 42 positioned above the middle fingertip marking 18c.

As explained above, the fingertip markings 18a-18e are representations of the player's actually fingerprints during contact with the basketball 10. Each of the fingertip markings 18a-18e has an interior 20a-20e surrounded by an outline 22a-22e, respectively. The width of each outline 22a-22e, and, correspondingly, the size of each interior 20a-20e, represents the relative contact time of the particular fingertip with the basketball 10. The thumb fingertip marking 18a and the little finger marking 18e have a relatively small interior 20a, 20e, respectively (showing less contact time for these fingers), whereas the middle finger marking 18c has a relatively large interior 20c (showing a greater contact time for this finger).

As illustrated, each interior 20a-20e is not necessarily centered within the respective fingertip marking 18a-18e, but is positioned to show the respective fingertip's last point of contact. Thus, the interior 20a of the thumb fingertip marking 18a is positioned slightly above and to the right of the geometric center of the fingertip marking 18a.

As illustrated in this embodiment, the player's middle finger is the final release point, i.e., the last part of the player's hand to touch the basketball 10 as it is shot (or passed). A final contact marking 26 within the interior 20c of the middle fingertip marking 18c shows the position of the player's final contact with the basketball.

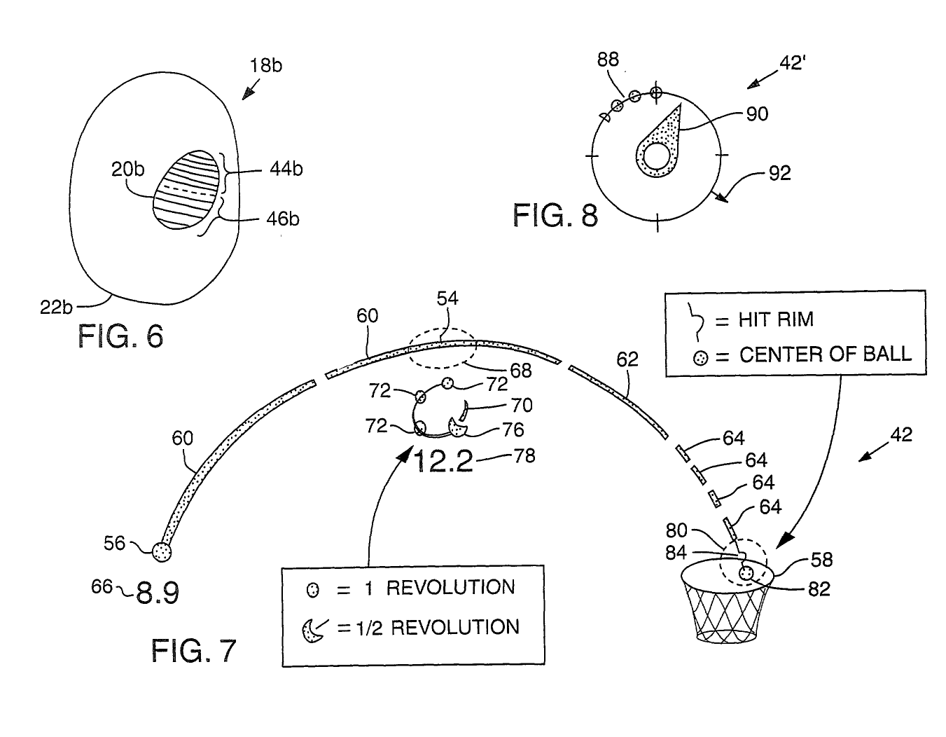

A detailed view of one fingertip marking, i.e., the index fingertip marking 18b, is shown in FIG. 6. As illustrated, the interior 20b is divided into first and second regions 44b and 46b. The regions 44b and 46b are ornamented to convey further release information, particularly how the basketball rolls off of the player's fingers, e.g., with a progressively changing color or colors. For example, if the first region 44b remains in contact with the player's index finger longer than the second region 46b, the first region 44b may be colored white, whereas the second region 46b is colored gold, with the intersection of the regions being a continuous transition between these colors. As explained above, other graphic representation styles or texture based marking can be used to implement the first region 44b and the second region 46b.

The pressure markings 24a-24e show the relative pressures exerted by the player's fingers in shooting or passing the basketball. In the illustrated embodiment, each pressure marking 24a-24e is a circle or a portion of a circle positioned around the corresponding fingertip marking 18a-18e. The pressure marking 24c for the middle finger is full circle to represent that this finger exerts the greatest pressure. The pressure markings 24b and 24d are each approximately ¾ of a circle. The pressure markings 24a and 24e are each approximately semicircular. Thus, for the illustrated embodiment, the pressure markings 24a-24e convey that the middle finger exerts the most pressure, the thumb and the little finger exert the least pressure, and the index and ring fingers exert an intermediate pressure.

The first graphic 28 shows a basketball court with a half court line 30 separating the left end from the right end, a key 32 in each end, and a basket 34 in the right end. Defensive team members 36 are each illustrated with an “X,” and offensive team members are each illustrated with an “O.” The player with the ball, in this case a “shooter,” is shown as a filled-in “O” 40. Thus, the first graphic 28 shows the position of the player whose fingertip representations are on the basketball 10 relative to the other players and the basket 34.

FIG. 7 shows the second graphic 42 in more detail. The second graphic 42 shows a representation of a basketball's trajectory 54 when “shot” by the shooter 40 toward the basket 32 with fingers positioned as shown in FIG. 4. At the left side or beginning of the trajectory is a release point 56, which indicates the shooter's release of the basketball. At the right side or end of the trajectory is a basket symbol 58 indicating the shot's successful passage through the rim and net. As illustrated, basket information 80 can include a center of the basketball representation 82 and a rim contact indicator 84.

The trajectory 54 includes major arc portions 60, minor arc portions 62 and incremental arc portions 64. These arc portions are designed to convey distance information graphically. For example, the arc portions can represent a linear distance from the shooter 40 (i.e., at the release point 56) to the basket 32. As illustrated, the major arc portions 60 represent each 10 linear feet, the minor arc portions each represent 5 linear feet and the incremental arc portions each represent 1 foot. Thus, the two major arc portions 60, the single minor arc portion 62 and the four incremental arc portions 64 together indicate that the trajectory 54 spans 29 feet along the court surface from the release point 56 to the basket 58.

Below the release point 56, the second graphic 42 can include a release height 66 indicating the height at which the ball was released to complete the shot. As illustrated, the release height 66 for the exemplary shot is 8 feet, 9 inches from the court surface, which is written in the convention “8.9.”

Adjacent a top 68 of the trajectory 54 is a rotation graphic 70. The rotation graphic 70 conveys information about how the ball rotates over the course of the trajectory 54 during the shot. As illustrated, the rotation graphic 70 includes full revolution markers 72 and a half revolution marker 76. Three full revolution markers 72 and one half revolution marker 76 are shown, thus indicating that the basketball rotated 3½ times during the shot. The rotation graphic 70 can also include coding to indicate whether the basketball is being rotated in a direction to have a “backspin” or a “forward spin.”

An arc height 78 is positioned below the rotation graphic 70. As illustrated, the height of the basketball at the top 68 of the trajectory (or arc) 54 was “12.2,” or 12 feet, 2 inches.

FIG. 8 shows an alternative second graphic 42′. Similar to the second graphic 42, the alternative second graphic 42′ conveys information on a basketball's movement during a shot or a pass. As illustrated, the alternative second graphic 42′ includes a rotation graphic 88, a rotation direction or “spin” indicator 90, and a ball speed indicator 92.

The rotation graphic 88 includes the same full revolution markers 72 and the half revolution marker 76 as described above. As illustrated, the rotation graphic 88 indicates that the basketball rotated 3½ times during the shot.

The rotation direction indicator 90, which, as illustrated, is a pointer, indicates the direction that the basketball rotates during the shot relative to the basketball's movement in translation (which is a straight line) from the player to the basket. In other words, the rotation indicator 90 indicates the spin direction and orientation. The rotation direction is given for the perspective of a shooter who is watching the basketball after he releases the shot. As illustrated, during the shot portrayed in FIG. 8, the rotation indicator 90 indicates that the basketball is spinning with forward spin (i.e., into the drawing page), and at angle to vertical.

The ball speed indicator 92 indicates the average speed of the basketball during the shot. For example, the basketball in the shot portrayed in the alternative second graphic 42′ travels at about 21 miles per hour. Thus, the ball speed indicator 92 is placed at a position corresponding to about 21 minutes after the hour. For a baseball implementation, a different scaling may be required, as baseball pitches can reach speeds of over 100 miles per hour, which would be more than once around a clock face.

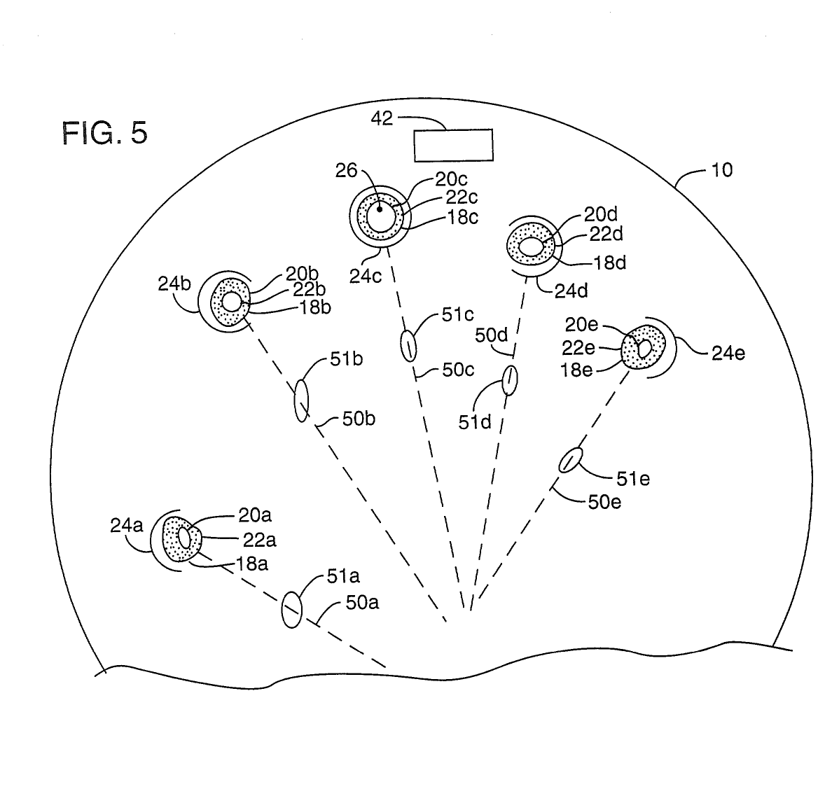

FIG. 5 shows another embodiment, similar to the embodiment of FIG. 4, but with finger axis lines 50a-50e instead of the first graphic 28. The lines 50a-50e can be used to scale the player's grip on the ball during the shot (i.e., through the fingertip markings 18a-18e) down to the smaller size of a user's hand. By aligning his fingers with the corresponding lines 50a-50e, the user will achieve the same approximate finger spread and fingertip placement as the player, as shown, e.g., by the user fingertip markings 51a-51e.

The same concept of surface ornamentation for a basketball can likewise be applied to a variety of other sports equipment. A few examples are reviewed below.

Footballs can be printed with the handprint of a player (e.g. Joe Montana) with the player's preferred hand arrayed in the position used to pass the football. Usually, such players position their hands on the laces of the football. While it is sometimes possible to imprint a football with surface ornamentation that extends over the laces, this is more difficult than simply patterning the pigskin surface (or synthetic equivalent), alone. If the fingertip markings cannot be be imprinted directly over the laces, they may be imprinted, e.g., to either side of the laces.

The same surface ornamentation can likewise be applied to baseballs. When throwing a baseball, however, the whole hand is typically not in contact with the ball surface (and is typically too large to illustrate in the manner discussed above for basketballs). Accordingly, for such embodiments, the surface ornamentation is in the nature of several fingerprints, e.g. thumb, index, and middle fingerprints, alone, or, smaller-sized fingerprints/fingertip markings, as necessary. Again, professional players commonly position their fingertips relative to the lacing that sews the ball, so strictly accurate printing of the surface ornamentation may not be practical.

Golf balls, too, can be provided with similar surface ornamentation (e.g. thumb and index fingerprints of Tiger Woods, positioned as he would typically do when picking a ball up out of a golf hole).

The golf ball case is one in which the functional value of design is nil—essentially no advantageous purpose is served by mimicking a professional golfer's placement of index finger and thumb when lifting a golf ball. However, the golf ball can of course be provided with the same sort of ornamental information as described above in connection with a basketball (e.g., hole, club used, swing speed, ball trajectory and path, contact point, roll, etc.).

The same characteristic feature can likewise be applied to non-ball objects, such as baseball bats, golf club grips, tennis racket grips, etc. For the latter, a single handprint can be employed; for the former, two handprints can be employed; for each the design would illustrate the hand position(s) by famous athletes as they would grip the same implements.

Having described the principles of my invention with reference to a several embodiments thereof, it should be apparent that the embodiments can be modified in arrangement and detail without departing from such principles.

I claim:

1. An item of sports equipment having functional markings provided thereon, the markings serving to place a user's hand on the item.

2. The item of claim 1 in which the markings include features facilitating correct hand placement use for users with variously-sized hands.

3. The item of claim 1 in which the item has plural markings, with different markings serving to aid in hand placement for different types of manipulations of the item.

4. The item of claim 3 in which the item is a basketball, one of said markings is for foul shooting, and another of said markings is for a manipulation other than foul shooting.

5. The item of claim 1 in which said markings guide the user as to the relative pressure to be applied at different points on the item.

6. The item of claim 1 in which said markings guide the user in a dynamic manipulation of the item.

7. The item of claim 6 in which said markings indicate variations in pressure over time.

8. The item of claim 6 in which said markings indicate variation in contact points over time.

9. The item of claim 6 in which the markings convey force-direction information to aid a user in manipulating the item.

10. The item of claim 6 in which said markings include plural colors to indicate the dynamic manipulation.

11. The item of claim 6 in which said markings include one color of plural different saturations.

12. The item of claim 1 in which said markings include plural different textures.

13. The item of claim 1 in which the item is a basketball.

14. The item of claim 1 in which the item is an item of baseball equipment.

15. The item of claim 1 in which the item is an item of golf equipment.

16. The item of claim 1 in which the markings comprise at least two of: different colors, different color saturations, and different textures.

17. An item of sports equipment having a coating thereon, said coating serving to determine the relative pressure applied to different points on the item.

18. The item of claim 17 in which the coating provides a visual indication of the relative pressure applied to said different points.

19. The item of claim 18 in which visual indication is transient.
